(19) United States
(12) Patent Application Publication
(10) Pub. No.: US 2004/0035120 A1
(43) Pub. Date: Feb. 26, 2004

(54) Storage container for cryogenic fuel

(76) Inventor: Klaus Brunnhofer, Graz (AT)

Correspondence Address: BACHMAN & LAPOINTE, P.C., 900 CHAPEL STREET, SUITE 1201, NEW HAVEN, CT, 06510, US

(21) Appl. No.: 10/297,659

(22) PCT Filed: Jun. 8, 2001
(86) PCT No.: PCT/AT01/00190

(30) Foreign Application Priority Data
Jun. 9, 2000 (AT) GM 437/2000

(51) Int. Cl. F17C 1/00; F17C 3/00; F17C 13/00

(52) U.S. Cl. 62/45.1; 220/560.1

(57) ABSTRACT

The invention relates to a storage container for a cryogenic propellant, especially hydrogen, having a double-walled construction comprising an interior and an exterior container (2, 3) and having a vacuum insulation and a multilayer insulation (4a) in the space between said interior and exterior containers (2, 3). Furthermore, a refrigeration line (9), through which a refrigerant can flow and which is in contact with the multilayer insulation (4a) and with a thermal shield (4b) set at a distance from the multilayer insulation (4a) and forms part of a refrigerant circuit is also present in the space between interior and exterior containers (2, 3).

The invention relates to a storage container for cryogenic propellant, having a double-walled construction comprising an interior and an exterior container and having a vacuum insulation and a multilayer insulation in the space between said containers.

Hydrogen has already been regarded for some time as the engine fuel of the future. For this purpose, the most sensible approach is to store the hydrogen on board various means of transport, such as aircraft, motor vehicles, etc., in liquid form or in the form of slush hydrogen. Liquid hydrogen is made available at a temperature of approximately 20 K and slush hydrogen at a temperature of approximately 13.8 K. The intention here is to take appropriate steps to ensure that the hydrogen retains this temperature in the storage container for as long as possible.

It is known in principle, in order to insulate storage containers or piping for cryogenic media, to provide a double-walled structure having a vacuum insulation acting between the double walls and a multilayer insulation disposed there. Such a storage container is known from U.S. Pat. No. 4,292,062. It is also known to attach an appropriate thickness of heat-insulating material, for example foam, to the outside of the containers or lines. Bulky, and therefore usually heavy, insulation of storage containers to be used in motor vehicles or aircraft is undesirable. The insulating measures known hitherto on storage containers for cryogenic hydrogen are inadequate, despite an elaborate construction. The result of this is that, when stored for extended periods within the storage container, hydrogen evaporates in a quantity such that the maximum operating pressure of the storage container is exceeded, so that the excess hydrogen vapor has to be blown off, which results both in a loss of fuel and in some degree of safety risk.

It is therefore an object of the present invention to configure a storage container for cryogenic propellant—especially for liquid hydrogen or slush hydrogen, but also for other cryogenic propellants, for example liquefied natural gas—in a manner such that, even in the event of long residence times, so little hydrogen evaporates that either the period before blowing-off becomes necessary is much longer than with the conventional systems or no blowing-off at all is still required. In particular, radiation losses to the exterior are to be as low as possible.

This object is achieved, according to the invention, in that a refrigeration line (9), through which a refrigerant can flow and which is in contact with the multilayer insulation and with a thermal shield set at a distance from the multilayer insulation, and forms part of a refrigerant circuit, extends in the space between the interior and exterior containers.

The radiation losses in a container embodied in accordance with the invention can be significantly reduced by the refrigeration of the multilayer insulation and of a further thermal shield. Thus, evaporation of the cryogenic propellant in the storage container can be at least substantially prevented. Therefore, either blowing-off is no longer necessary at all or the period before it becomes necessary may be much longer than was the case with the storage containers known previously.

In a preferred embodiment of the invention, provision is made for the multilayer insulation to enclose, at least substantially, the interior container, for the thermal shield to be disposed outside the multilayer insulation and for the refrigeration line to extend between the multilayer insulation and the thermal shield (claim 2). In this manner, refrigeration of the multilayer insulation and simultaneous refrigeration of the thermal shield can take place particularly effectively.

If necessary, the fuel can also be refrigerated within the interior container by the refrigeration circuit provided. For this purpose, at least one further refrigeration line through which a refrigerant can flow is provided inside the interior container and can be optionally connected into the refrigeration circuit or disconnected therefrom (claim 3). The refrigeration circuit is operated in a particularly simple and effective manner by an external refrigeration unit, which is in particular in (sic) pulse tube refrigerator a Sterling refrigerator (claims 4 and 5).

The efficiency of the thermal shield is particularly good when the latter consists of a particularly heat-conductive material such as aluminum and surrounds the multilayer insulation as completely as possible (claims 6 and 7). Examples of suitable refrigerants are gaseous helium and nitrogen. In these cases, the refrigerant can be fed into the refrigeration circuit at a temperature lower than the temperature of the cryogenic propellant (claim 8). This is expedient when refrigerant flows through the refrigeration line within the container, which is in contact with the cryogenic propellant. If this refrigeration line is disconnected from the refrigeration circuit and refrigerant flows only through the refrigeration line or refrigeration lines between the interior and exterior containers, the temperature of the refrigerant may also be somewhat higher than the temperature of the cryogenic propellant.

If the refrigeration line within the container is connected into the refrigeration circuit, the refrigeration output of the refrigerant, for example the gaseous helium, can be particularly well exploited if the refrigerant passes first through the refrigeration line system in the interior of the container and subsequently through the refrigeration line(s) between interior and exterior containers (claim 9). For optimum refrigeration, it is also advantageous if an electronic control and regulation system is provided whereby the refrigeration system can be controlled, in particular as a function of the rate of through flow, the quantity of through flow and the temperature of the refrigerant at various points (claim 10).

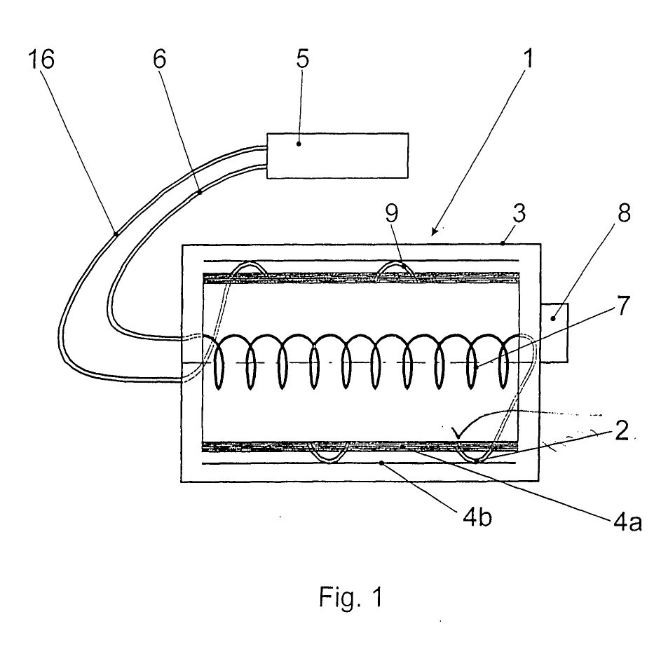

Transfer of heat into the interior of the storage container can be further reduced if the interior container is magnetically suspended without contact (claim 11). Further features, advantages and details of the invention will now be described in detail with reference to the drawing, which represents an example of embodiment of a storage container according to the invention. In the drawing, the single figure (FIG. 1) shows a longitudinal section through a storage container which is merely shown diagrammatically. Also shown is a refrigeration unit disposed outside the container and interacting therewith.

As the single figure of the drawing shows, the storage container 1 consists of an exterior container 3 and an interior container 2. The two containers 2, 3 possess a matching design, being for example of cylindrical configuration. The distance between the interior and exterior containers 2, 3 is preferably selected to be equally great for the entire storage container 1. The two containers 2, 3 may be produced from stainless steel, from aluminum or from a glass fiber composite. The distance between the interior and exterior containers 2, 3 is of the order of magnitude of from a few millimeters to a few centimeters.

The filling of the storage container 1 with a liquid propellant, for example hydrogen or slush hydrogen, and the removal thereof for the operation of an engine, for example a motor vehicle engine, are not subjects of the present invention. The measures necessary for this purpose are therefore not shown or described and may be undertaken in a conventional manner.

The space between the two containers 2, 3 is used to insulate the interior space of the storage container 1. Insulating measures provided are vacuum insulation—by creating and maintaining a vacuum in the space between the two containers 2, 3—and, in the space between the containers 2, 3, a multilayer insulation 4a and a thermal shield 4b. The multilayer insulation 4a consists in a manner known per se of a number of layers of foil, with a reflective finish on one side, for example paper coated with aluminum. The multilayer insulation 4a comprises, for example, from 10 to 20 layers of layers (sic) disposed on the outer side of the interior container 2, the reflective sides being aligned parallel with the surface of the interior container 2. At a distance from the exterior container 3, the multilayer insulation 4a is surrounded by the thermal shield 4b, which for its part is disposed at a distance from the inside of the exterior container 3.

The thermal shield 4b is matched to the shape of the interior container 2 and thus, in the case of a round container 2, is a cylindrical part made from metal, especially from aluminum or from another metal which conducts heat, is reflective and is resistant to low temperatures.

A refrigeration line 9, which is part of a refrigeration circuit, runs between the thermal shield 4b and the multilayer insulation 4a. The refrigeration line 9 runs around the multilayer insulation 4a helically, in coils, and in doing so is in contact both with the latter and with the thermal shield 4b. A refrigerant, details of which are given below, flows through the refrigeration line 9.

The refrigeration circuit is operated by a refrigeration unit 5, which may be a pulse tube refrigerator or a Sterling refrigerator. Pulse tube refrigerators are known in various embodiments, reference being made in this respect by way of example to the pulse tube refrigerators disclosed by U.S. Pat. No. 5,791,149 and U.S. Pat. No. 5,966,943, which may be used in the context of the present invention. By means of the pulse tube refrigerator, a refrigerant, such as gaseous helium where hydrogen is used as the propellant, can be refrigerated to a temperature of, for example, 16 K and passed into the refrigeration system circuit.

A further component of the refrigeration circuit is a refrigeration line 7, extending in the interior of the storage container 1, which refrigeration line 7 can be supplied by the refrigeration unit 5 via an appropriately insulated line 6 and preferably refrigerates the cryogenic propellant located in the interior of the storage container 1 helically and by means of the refrigerant. The figure of the drawing shows diagrammatically only a single helically extending refrigeration line 7, but a much more complexly configured refrigeration line system may be provided in the interior of the storage container 1, in particular in order to guarantee effective refrigeration of the quantity of propellant located in the storage container 1 with different filling levels of cryogenic propellant. Instead of a helical shape, a serpentine course of the refrigeration line 7 in the interior of the storage container 1 may also be provided. The coils or spirals of the refrigeration line 7 also effectively reduce slopping of the propellant.

The refrigeration line(s) 7 extend or extends in particular in the longitudinal direction of the storage container 1 and open or opens, in particular, at the end region, remote from the feed, of the storage container 1 into the further refrigeration line 9, which runs helically around the multilayer insulation 4a in the space between the two containers 2, 3. As a result, the refrigerant is again returned to the original feed region. Outside the storage container 1, the refrigerant is returned to the refrigeration unit 5 via a further, appropriately insulated line 16.

Via an appropriately designed electronic control system 8, the refrigeration and the refrigeration performance can be regulated and controlled, for example taking into consideration the through flow quantity and the through flow rate of the refrigerant and as a function of its temperature at different points in the refrigeration system. If, therefore, for example, gaseous helium at a temperature of approximately 16 K is fed into the refrigeration line or the refrigeration line system 7, it is possible to ensure by means of the temperature control system 8 that the gaseous helium enters the refrigeration line 9 extending between the two containers 2, 3 at a temperature of approximately 20 K. Refrigeration of the multilayer insulation 4a and of the thermal shield 4b now takes place here, further warming of the gaseous helium to, for example, approximately 24 K having possibly taken place at the exit from the storage container 1. Via the line 16, the gaseous helium is returned to the refrigeration unit 5 and again refrigerated to the desired initial temperature.

In an alternative embodiment of the storage container (not shown), provision may be made to disconnect the refrigeration lines 7 in the interior of the container from the refrigeration circuit and only to supply with refrigerant the refrigeration line(s) 9 between the interior and exterior containers 2, 3. If necessary, the refrigeration line(s) 9 can be (automatically) reincorporated into the circuit. If the refrigeration line(s) 9 is or are disconnected, the refrigeration circuit may be operated with a refrigerant at a correspondingly higher temperature.

By means of the invention, it is readily possible to increase significantly the storage times before any necessary blowing-off of propellant vapor formed in the storage container 1. By an appropriate design of the active refrigeration system and of the passive insulation, it may even be possible substantially to prevent evaporation of the cryogenic propellant located in the storage container. Evaporating hydrogen gas can, moreover, generate electrical current via fuel cells, which can be used to operate the pulse tube refrigerator.

In order further to reduce the transfer of heat from the exterior container, which is at ambient temperature, to the cold interior container, the interior container may be suspended without contact by means of superconductors and strong permanent magnets. Such configurations have already been proposed in the literature, and in this context reference is made by way of example to the article “LH₂-Kryobehälter mit HTSS-Lagerung des Innentanks (LH₂ Cryotanks with HTS Mounting of the Inner Tank)”, VDI Cryotechnology Conference (Gelsenkirchen, October 1998).

Propellant tanks configured according to the invention may also be used for propellants other than hydrogen. Examples of suitable propellants include liquefied natural gas, nitrogen being a suitable refrigerant in this case.

Mention should also be made of the fact that the use of a storage container 1 configured according to the invention is not confined to motor vehicles.

1. Storage container for cryogenic propellant, especially hydrogen, having a double-walled construction comprising an interior and an exterior container (2, 3) and having a vacuum insulation and a multilayer insulation (4a) in the space between said interior and exterior containers (2, 3), characterized in that a refrigeration line (9), through which a refrigerant can flow and which is in contact with the multilayer insulation (4a) and with a thermal shield (4b) set at a distance from the multilayer insulation (4a), and forms part of a refrigerant circuit, extends in the space between the interior and exterior containers (2, 3).

2. Storage container according to claim 1, characterized in that the multilayer insulation (4a) encloses, at least substantially, the interior container (2), in that the thermal shield (4b) is disposed outside the multilayer insulation (4a) and in that the refrigeration line (9) extends between the multilayer insulation (4a) and the thermal shield (4b).

3. Storage container according to claim 1 or 2, characterized in that the propellant can be cooled within the interior container (2) via at least one further refrigeration line (7) through which a refrigerant flows and which, when necessary, can be connected into the refrigerant circuit.

4. Storage container according to one of claims 1 to 3, characterized in that the refrigerant circuit can be operated by an external refrigeration unit.

5. Storage container according to claim 4, characterized in that the refrigeration unit (5) is a pulse tube refrigerator or a Sterling refrigerator.

6. Storage container according to one of claims 1 to 5, characterized in that the thermal shield (4b) consists of a heat-conducting metal, for example aluminum.

7. Storage container according to one of claims 1 to 6, characterized in that the thermal shield (4b) encloses the multilayer insulation (4a) and/or the interior container (2) substantially completely.

8. Storage container according to one of claims 1 to 7, characterized in that the refrigerant is fed into the refrigeration circuit at a temperature lower than the temperature of the cryogenic propellant and is preferably gaseous helium or nitrogen.

9. Storage container according to one of claims 1 to 8, characterized in that the refrigerant passes first through the refrigeration line (7) in the interior of the container (1) and subsequently through the refrigeration line (9) between the interior and exterior containers (2, 3).

10. Storage container according to one of claims 1 to 9, characterized in that an electronic control system (8) is provided, whereby the refrigeration system can be controlled, in particular as a function of the rate of through flow, the quantity of through flow and the temperature of the refrigerant at various points.

11. Storage container according to one of claims 1 to 10, characterized in that the interior container (3) is magnetically suspended without contact.
